(19) United States
(12) Patent Application Publication
(10) Pub. No.: US 2016/0199155 A1
(43) Pub. Date: Jul. 14, 2016

(54) Orthodontic Brackets

(71) Applicant: Rutgers, The State University of New Jersey, New Brunswick, NJ (US)

(72) Inventors: Jose A. Bosio, Basking Ridge, NJ (US); Thomas J. Cangialosi, Rumson, NJ (US)

(21) Appl. No.: 14/594,853

(22) Filed: Jan. 12, 2015

(51) Int. Cl. A61C 7/28

(52) U.S. Cl. CPC A61C 7/282

(57) ABSTRACT

An orthodontic device a base having a central longitudinal plane and a plurality of posts extending relative to the base. In one aspect, the posts are positioned with a first subset of at least one post on one side of the central longitudinal plane and a second subset of at least one post positioned on the opposite side of the central longitudinal plane such that facing first surfaces define a first slot with a first width and facing second surfaces define a second slot above the first slot with a second width larger than the first width and wherein a passage defined from the second slot to the first slot. In another aspect, the posts are angled relative to the base such that the posts converge as they approach the base.

### FIELD OF THE INVENTION

This disclosure relates to orthodontics. More particularly, the disclosure relates to orthodontic brackets, tubes and wires having configurations which provide greater flexibility in use.

### BACKGROUND OF THE INVENTION

Orthodontics have long been utilized for altering the positions of teeth to provide a more desirable appearance, to correct malocclusion of teeth, and to correct facial deformities. Various orthodontic appliances have been employed to apply corrective forces to respective teeth to reposition the teeth in accordance with the direction and extent of the applied forces. Referring to FIGS. 1 and 2, such appliances have generally or typically been utilized with conventional associated components, such as bands 10 secured as by cementing about respective teeth, brackets 12 secured as by welding to the bands 10 and cemented to the teeth or directly bonded to the teeth, and archwire 20 which extends about a plurality of teeth and is disposed in a slot 14 in each respective bracket 12. The archwire 20 is held to each bracket 12 with a ligature 22, which can be, for example, a tiny elastic or a twisted wire. Elastic hooks 16, 18 may extend from the brackets 12 or archwire 20 and are used for the attachment of rubber bands 24, which help move teeth toward their final position. The appropriate installation of appliances relative to the archwire 20 and the brackets 12 results in the transmission of appropriate corrective forces to respective teeth, thereby effecting the desired repositioning of teeth over a period of time.

Millions of patients are currently undergoing orthodontic treatment worldwide utilizing such brackets 12 and archwire 20. The archwire 20 is generally provided in various standardized sizes, between 0.012-inches and 0.025-inches, and typically is either square or round. To accommodate the different archwires and achieve the desired benefit therefrom, two different major standard brackets 12 are utilized, ones with slots 14 that are 0.018-inches in width and ones with slots 14 that are 0.022-inches in width. Few unsuccessful suggestions and attempts have been made to standardize the size of the brackets slot into one size only. Despite the requests, need, desires and recognition, the orthodontic community, professionals and orthodontic manufacturing companies, remain with the 4 thousand of an inch difference in slot size.

Thus, since no agreement has been reach among the orthodontic community, it becomes imperative to find an alternative.

### SUMMARY OF THE INVENTION

In at least one embodiment, the present disclosure provides a bracket system including an active design involving two slot sizes, 0.018-inch and 0.022-inch, developed into the same device. This bracket system will allow practitioners to continue with their technique, remain with their current archwire inventories, incorporate new double size archwires, and take the advantages of both techniques. The bracket is designed to be active at all time, extracting the best properties from both slot size systems for treating orthodontic cases.

In at least one embodiment, the present disclosure provides an orthodontic bracket including a base having a central longitudinal plane and a plurality of posts extending relative to the base. Each post extends from a connection portion to a free end and includes an internal surface which faces the central longitudinal plane. Each internal surface defines, starting at the connection portion, a first surface which is substantially parallel to the central longitudinal plane, an outwardly extending shoulder above the first surface and a second surface above the shoulder which is substantially parallel to the central longitudinal plane. The posts are positioned with a first subset of at least one post on one side of the central longitudinal plane and a second subset of at least one post positioned on the opposite side of the central longitudinal plane such that the facing first surfaces define a first slot with a first width and the facing second surfaces define a second slot above the first slot with a second width larger than the first width. A space between the opposed shoulders defines a passage from the second slot to the first slot.

In at least one embodiment, the present disclosure provides an orthodontic bracket including a base defining a central longitudinal plane and a central transverse plane. At least four posts extend relative to the base with at least two posts on one side of the central longitudinal plane and at least two posts on the other side of the central longitudinal plane such that at least one slot is defined between the posts on opposite sides of the central longitudinal plane. Each of the posts extends at a first angle of about 25 degrees or more relative to the central longitudinal plane and a second angle of about 25 degrees or more relative to the transverse longitudinal plane.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a side perspective view of exemplary prior art orthodontic appliances positioned on teeth.

FIG. 2 is a perspective view of an exemplary prior art bracket.

FIG. 3 is a perspective view of a bracket in accordance with an exemplary embodiment of the disclosure.

FIG. 4 is an end elevation view of the bracket of FIG. 3.

FIG. 5 is a top plan view of the bracket of FIG. 3.

FIG. 6 is a bottom plan view of the bracket of FIG. 3.

FIG. 7 is a perspective view of a buccal tube in accordance with an exemplary embodiment of the disclosure.

FIG. 8 is a perspective view of a double section archwire in accordance with an exemplary embodiment of the disclosure.

FIG. 9 is a top plan view of a bracket in accordance with another exemplary embodiment of the disclosure.

FIG. 10 is an end elevation view of the bracket of FIG. 9.

FIG. 11 is a side elevation view of the bracket of FIG. 9.

FIG. 12 is an end elevation view of a bracket in accordance with another exemplary embodiment of the disclosure.

FIG. 13 is an end elevation view of a bracket in accordance with another exemplary embodiment of the disclosure.

FIG. 14 is an end elevation view of a buccal tube in accordance with another exemplary embodiment of the disclosure.

FIG. 15 is a top plan view of the buccal tube of FIG. 14.

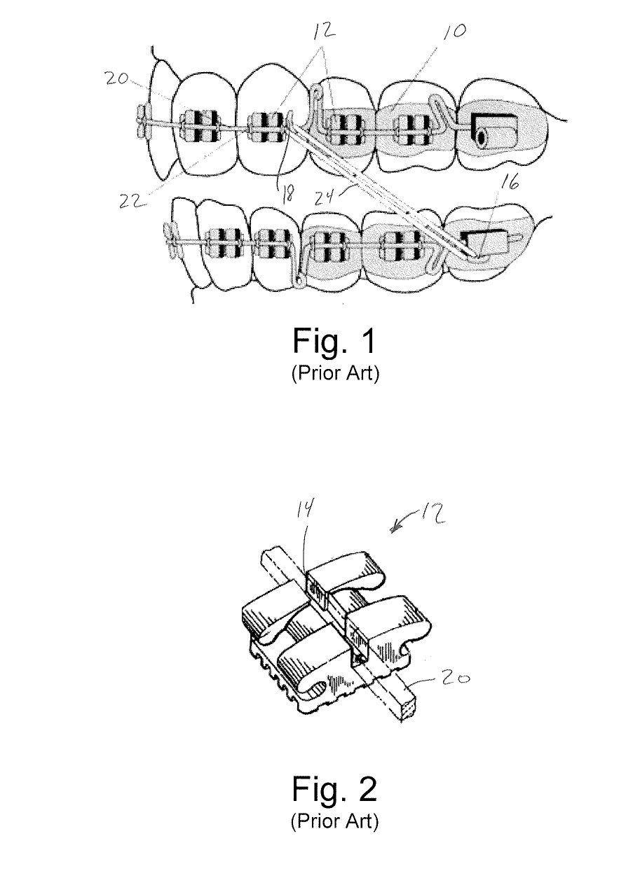

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

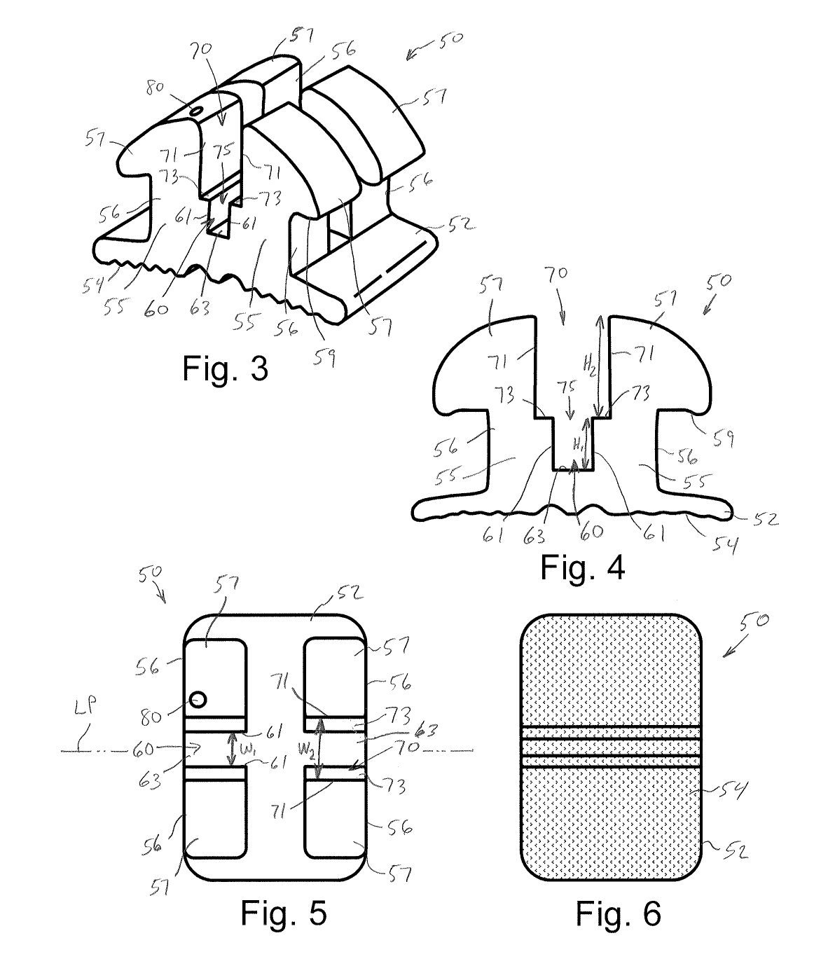

Referring to FIGS. 3-6, a bracket 50 in accordance with an embodiment of the disclosure will be described. The bracket 50 includes a base 52 which is illustrated as slightly curved in the longitudinal direction, but may have other configurations, for example, curved also in the transverse direction or alternatively may be planar, depending on the curvature of the teeth. The posterior surface 54 of the base 52 has indentations, or the like, for penetration of the bonding agent, which holds the bracket 50 attached to the teeth.

A plurality of posts 56 extend from the anterior surface of the base 52. Each post 56 extends from a connection portion 55 to a free head 57. The heads 57 may define outwardly extending lips 59. In the illustrated embodiment, the bracket 50 includes four posts 56, with two on one side of the central longitudinal plane LP and the other two opposed thereto on the opposite side of the central longitudinal plane LP. While four posts 56 are illustrated, the bracket 50 may include more or fewer. Additionally, while the posts 56 on opposite sides of the longitudinal plane LP are illustrated in alignment with a corresponding post, it is understood that the posts may be offset from one another. For example, one side of the longitudinal plane LP may include two posts spaced apart while the opposite side of the longitudinal plane LP may include a single post aligned with the space between the other two posts. Other configurations are also possible. In use, the bracket 50 will be positioned such that the longitudinal plane LP extends in the mesiodistal direction. While the posts 56 are illustrated as having the same configuration, it is recognized that the posts may have different configurations. For example, the cervical posts may be longer than the occluso/incisal ones. This enhancement would make the elastic retention better either for correction of Class II or Class III types of malocclusion.

An inside surface of the base portion 55 of each post 56 defines a side wall 61 of a first slot 60. The first slot 60 extends along the base 52 and is defined by the opposed side walls 61 and a portion of the base 52 which defines the bottom surface 63 of the slot 60. The first slot 60 has a first width W1 and a first height H1. As an example, the first width W1 may be equal to the standardized width of 0.018-inches, however, the invention is not limited to such. The first slot 60 preferably has a height H1 of 0.022-inches to 0.025-inches, however, the invention is not limited to such. The height H1 of the slots 60 can be modified to fit the manufacturing and application specifications.

Beyond the height of the first slot 60, the inside surface of each post 56 extends outwardly along shoulder 73 before again extending substantially parallel to the longitudinal plane LP to define a respective side wall 71 of a second slot 70. The second slot 70 is defined by the opposed side walls 71 and the shoulders 73 define the bottom surface of the slot 70. The second slot 70 has a second width W2 and a second height H2. As an example, the second width W2 may be equal to the standardized width of 0.022-inches, however, the invention is not limited to such. The second slot 60 preferably has a height H2 of about 0.025-inches, however, the invention is not limited to such.

As can be seen, the second slot 70 is positioned above the first slot 60, preferably with both centered relative to the central longitudinal plane LP. A passage 75 between the shoulders 73 defines an opening from the second slot 70 into the first slot 60. In use, the practitioner can use a smaller archwire 20 by passing it through the second slot 70, through the passage 75 and into the first slot 60. The archwire 20 will function within the slot 60 in the same manner it would utilizing a prior art bracket having a standardized 0.018-inch slot. If the practitioner prefers to use a larger archwire 20 for a particular application, the archwire 20 would be positioned within the second slot 70. The shoulders 73 would prevent the larger archwire 20 from passing into the first slot 60 and the archwire 20 will remain within the second slot 70 and will function in the same manner it would utilizing a prior art bracket having a standardized 0.022-inch slot. With such configuration, there is no more need for fabrication of two slot size brackets with the same prescription, which, in turn, could potentially allow the industry to reduce its manufacturing costs, and the practitioners benefit from the advantages of both slot size techniques in the same bracket 50. Additionally, the bracket 50 can facilitate the use of two archwires, one in each of the slots 60, 70 for the purpose of aligning a mal-positioned, rotated or impacted individual tooth.

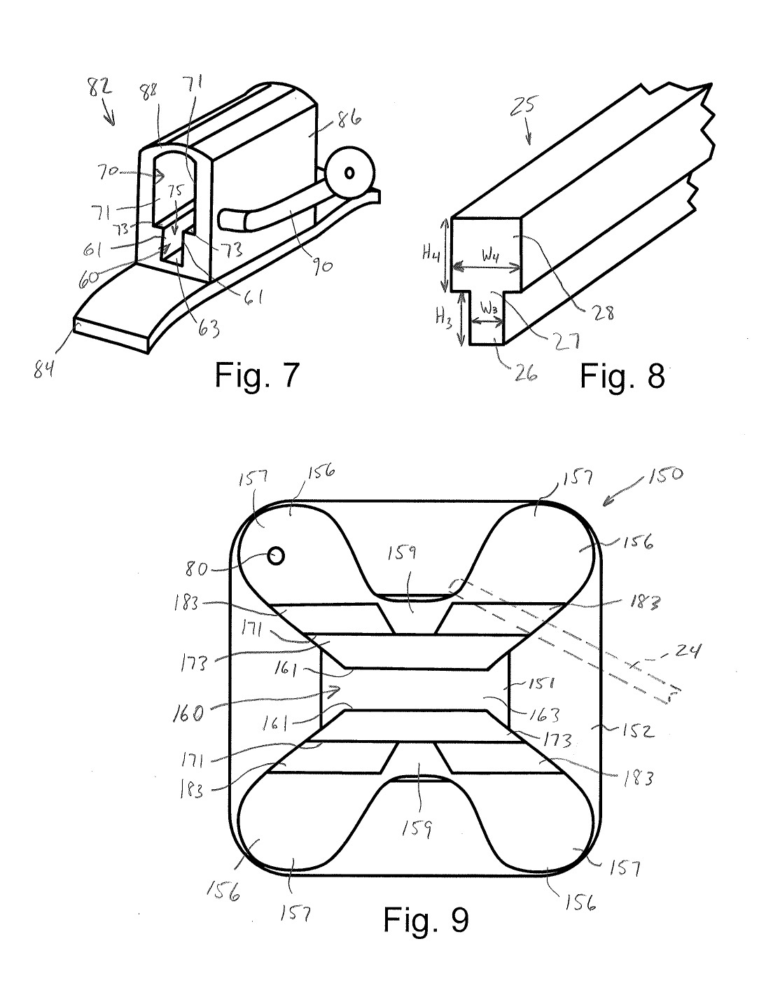

Generally, each end of the archwire 20 is retained within a buccal tube secured to a band or secured directly to a tooth. To facilitate the flexibility of the dual slot size, FIG. 7 illustrates an exemplary buccal tube 82 including two slots 60 and 70 similar to the slots in the bracket 50. The buccal tube 82 includes a base 84 with a tubular housing 86 positioned thereon. The tubular housing 86 defines the bottom surface 63 and side walls 61 of the first slot 60 and the side walls 71 and shoulders 73 of the second slot 70. The tubular housing 86 also defines a covering portion 88 which extends across the top of the second slot 70 opposite the shoulders 73 and passage 75. The covering portion 88 closes the second slot 70 to define the enclosed tubular passage, comprising the first and second slots 60 and 70. A ball hook 90 or the like may extend from the tubular housing 86 for use in a manner similar to known buccal tubes.

Referring to FIG. 8, the bracket 50 and tube 82 also facilitate the use of a double section archwire 25 having a narrow portion 26 and a wide portion 28 interconnected at a common area 27. The narrow portion has a width W3 and a height H3 which are configured to fit within the first slot 60. The wide portion has a width W4 and a height H4 which are configured to fit within the second slot 70. Both portions 26, 28 of the double section archwire 25 can be of various sizes. As an example, the narrow portion 26 may have a width W3 of 0.016 inches and a height H3 of 0.022 inches while the wide portion 28 have a width W4 of 0.019 inches and a height H4 of 0.025 inches. The double section archwire 25 can be made of many different wire components, for example, Nickel-Titanium, Stainless Steel, Tungstenium-Molybdenum, Cooper-Titanium, plastic material, or any other composition which eventually may be created. Such a double section archwire 25 may present some performance benefits such as twist-resistance, strength, and/or prevention of food or objects getting into the first slot 60.

The brackets 50 and tubes 82 may be mounted to address each individual tooth of the mouth which will have its own angulation, inclination and torque, as set forth in the table below.

TABLE 1
Individual Torque, Angulation and In/Out Rotation:

| Teeth | Torque | Angulation | In/Out (Inches) |
|---|---|---|---|
| Maxillary | | | |
| Central | 15 | 3 | 0.018 |
| Lateral | 8 | 7 | 0.028 |
| Canine | −5 | 10 | 0.014 |
| 1^{st} Premolar | −5 | 0 | 0.018 |
| 2^{nd} Premolar | −5 | 0 | 0.014 |
| 1^{st} Molar | −7 | 0 | 0.022 |
| 2^{nd} Molar | −7 | 0 | 0.022 |
| Mandibular | | | |
| Central and Lateral | −3 | 0 | 0.032 |
| Canine | −4 | 4 | 0.010 |
| 1^{st} Premolar | −8 | 3 | 0.012 |
| 2^{nd} Premolar | −8 | 3 | 0.012 |
| 1^{st} Molar | −12 | 2 | 0.018 |
| 2^{nd} Molar | −12 | 2 | 0.018 |

Referring to FIGS. 9-11, a bracket 150 in accordance with another exemplary embodiment of the disclosure will be described. The bracket 150 includes a base 152 which is illustrated as planar, but may have other configurations, for example, curved in one or both of the longitudinal and transverse directions, depending on the curvature of the teeth. The posterior surface 154 of the base 152 has indentations, or the like, for penetration of the bonding agent, which holds the bracket 150 attached to the teeth.

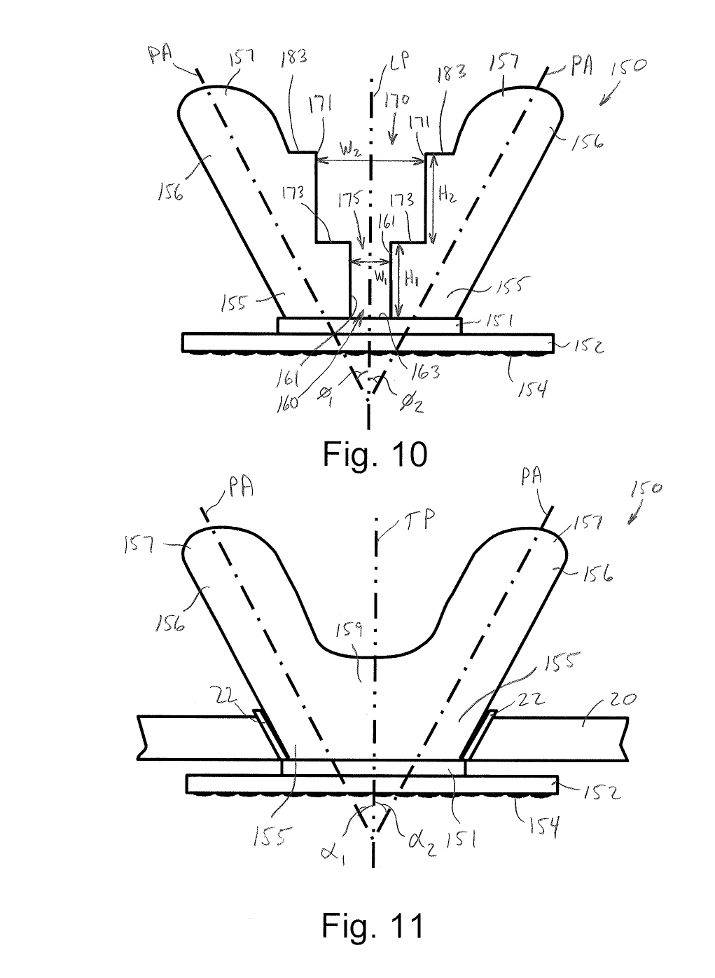

A plurality of posts 156 extend from a pedestal 151 which is mounted on the anterior surface of the base 152. While a pedestal 151 is illustrated, it is understood that the posts 156 may connect directly to the base 152. Each post 156 extends from a connection portion 155 to a free end 157 with a post axis PA extending therebetween. With reference to FIGS. 10 and 11, each post 156 extends at angle in both the longitudinal and transverse directions relative to the pedestal 151 such that the connection ends 155 converge at the pedestal 151. More specifically, each post 156 extends at an angle θ relative to the central longitudinal plane LP. The angles are noted as θ₁, θ₂ as it is contemplated that the posts 156 on opposite sides of the longitudinal plane LP may extend at different angles. Similarly, each post 156 extends at an angle a relative to the central transverse plane TP. The angles are noted as α₁, α₂ as it is contemplated that the posts 156 on opposite sides of the transverse plane TP may extend at different angles. The angles θ₁, θ₂ and α₁, α₂ are each about 25 degrees or greater and preferably 45 degrees or greater. If less than 45 degrees, the posts 156 may not be retentive for the elastomeric bands, as described hereinafter. In one exemplary embodiment, the angles α₁, α₂ are greater than the angles θ₁, θ₂ such that the posts are a little more inclined towards the mesial and distal portions of the bracket. This will reduce the height of the bracket 150 as a whole and will reduce the span between brackets which will add to the rigidity of the wire.

Each of the posts 156 is preferably larger at the free end 157 and gradually narrower as it approaches the pedestal 151. The posts 156 shall be sufficiently sized to prevent bending by the mastication forces. As shown in FIG. 11, a bridging portion 159 may extend between adjacent posts across the transverse plane TP to provide additional strength and to support the second slot as described hereinafter. At the free ends 157, the portion facing the mucosa of the cheeks and lips is preferably rounded on the corners.

Referring to FIGS. 9 and 10, an inside surface of the base portion 155 of each post 156 defines a side wall 161 of a first slot 160. The first slot 160 extends along the pedestal 151 and is defined by the opposed side walls 161 and a portion of the pedestal 151 which defines the bottom surface 163 of the slot 160. The first slot 160 has a first width W1 and a first height H1. As an example, the first width W1 may be equal to the standardized width of 0.018-inches, however, the invention is not limited to such. The first slot 160 preferably has a height H1 of 0.022-inches to 0.025-inches, however, the invention is not limited to such. The height H1 of the slots 160 can be modified to fit the manufacturing and application specifications.

Beyond the height of the first slot 160, the inside surface of each post 156 extends outwardly along shoulder 173 before again extending substantially parallel to the longitudinal plane LP to define a respective side wall 171 of a second slot 170. The second slot 170 is defined by the opposed side walls 171 and the shoulders 173 define the bottom surface of the slot 170. The second slot 170 has a second width W2 and a second height H2. As an example, the second width W2 may be equal to the standardized width of 0.022-inches, however, the invention is not limited to such. The second slot 60 preferably has a height H2 of about 0.025-inches, however, the invention is not limited to such. A second set of shoulders 183 may be defined above the second slot 170. The function of the shoulders 183 will be described hereinafter.

As can be seen, the second slot 170 is positioned above the first slot 160, preferably with both centered relative to the central longitudinal plane LP. A passage 175 between the shoulders 173 defines an opening from the second slot 170 into the first slot 160. In use, the practitioner can use a smaller archwire 20 by passing it through the second slot 170, through the passage 175 and into the first slot 160. The archwire 20 will function within the slot 160 in the same manner it would utilizing a prior art bracket having a standardized 0.018-inch slot. If the practitioner prefers to use a larger archwire 20 for a particular application, the archwire 20 will be positioned within the second slot 170. The shoulders 173 will prevent the larger archwire 20 from passing into the first slot 160 and the archwire 20 will remain within the second slot 70 and will function in the same manner it would utilizing a prior art bracket having a standardized 0.022-inch slot.

Again, with such configuration, there is no more need for fabrication of two slot size brackets with the same prescription, which, in turn, could potentially allow the industry to reduce its manufacturing costs, and the practitioners benefit from the advantages of both slot size techniques in the same bracket 50. Additionally, the bracket 50 can facilitate the use of two archwires, one in each of the slots 60, 70, for example, during alignment of one mal positioned or impacted tooth, where one wire serves as the heavy base wire and the other lighter wire is attached to the mal positioned tooth. Using double section archwire can enhance some orthodontic treatments, favoring leveling and alignment.

Referring to FIG. 11, an illustrative archwire 20 is illustrated extending through the first slot 160 and is secured therein by ligature 22. The angulation of the posts 156 helps to maintain the ligature 22 in position and, if elastomeric, the elastomeric ligature becomes active continuously. Additionally, as illustrated in FIG. 9, the angulation of the posts 156 allows the posts 156 to be utilized for attachment of interdental elastomeric bands 24 or the like without the need for additional hooks. The second shoulders 183 may support receipt of the bands 24. However, the posts 156 may have auxiliary hooks attached to them, to increase the retention for the interdental elastics.

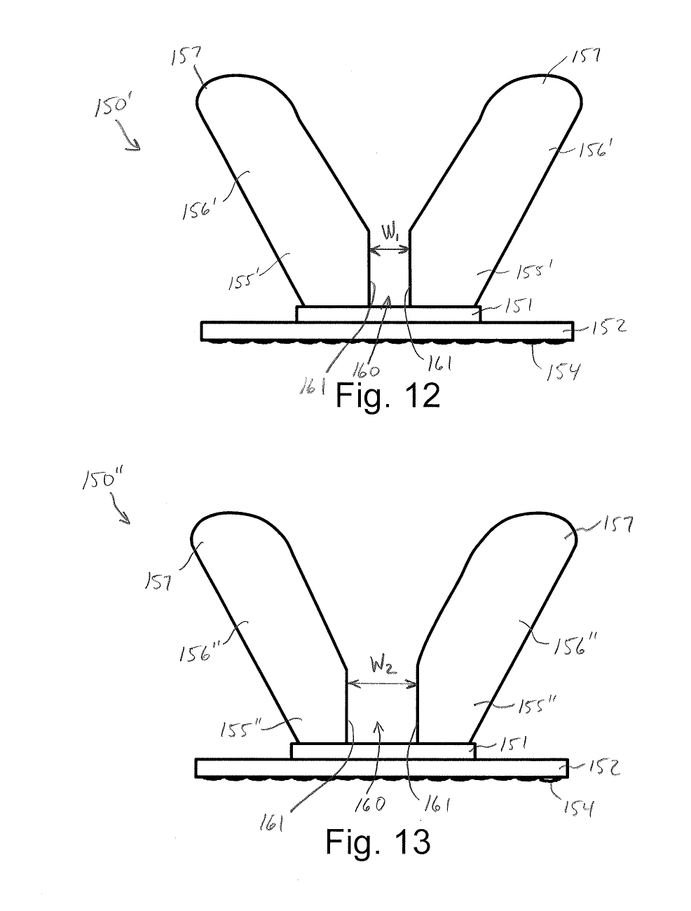

While the bracket 150 may be formed with first and second slots 160, 170, FIGS. 12 and 13 illustrate alternative embodiments of the bracket 150′ and 150″, each of which includes converging posts, however, only includes one slot 160. For example, the bracket 150′ in FIG. 12 includes converging posts 156′ wherein the connection portion 155′ is configured such that only the side walls 161 are defined and are spaced from one another a single distance W1. The bracket 150′ in FIG. 13 includes converging posts 156″ wherein the connection portion 155″ is configured such that only the side walls 161 are defined and are spaced from one another a single distance W2. Such a bracket system would provide the benefits of the convergent posts 156 described herein, but would provide only a single slot width.

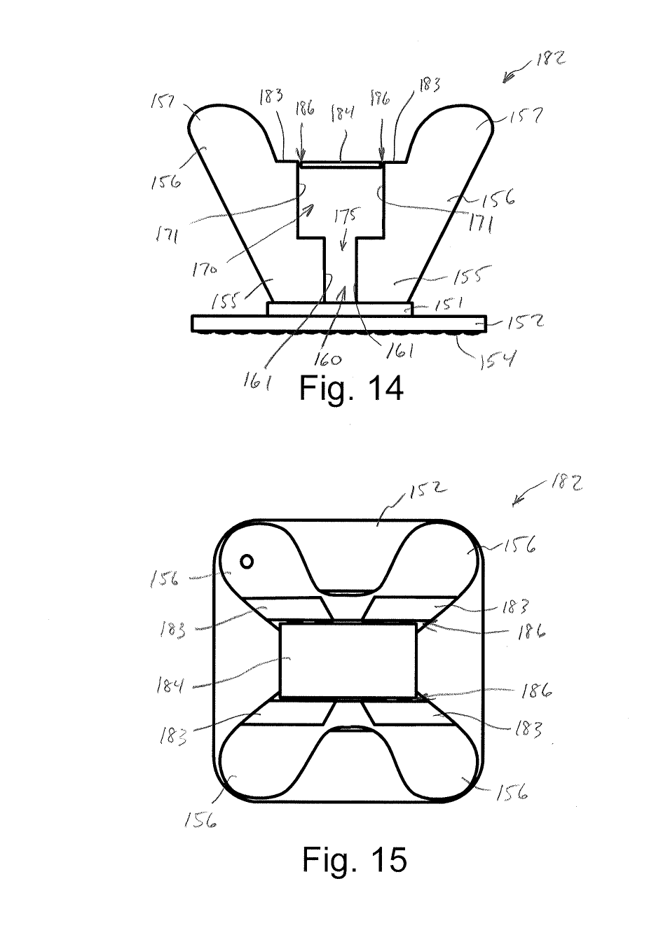

Referring to FIGS. 14 and 15, an alternative buccal tube 182 will be described. The buccal tube 182 is similar to the bracket 150 accept that a covering plate 184 is secured over the open end of the second slot 170. In the illustrated embodiment, welding seems 186 extend between each edge of the covering plate 184 and the second shoulders 183. Alternatively, the covering plate 184 may be formed integrally with the posts 156. In at least one embodiment, the welding seems 186 are frangible such that the covering plate 184 may be removed, thereby transforming the buccal tube 182 into a bracket 150. The angulation of the posts 156 may illuminate the need for any additional hooks on the buccal tube 182.

Referring to FIGS. 3, 5 and 9, the brackets 50, 150, 150′, 150″ may be marked with an indicator 80 to identify the type of bracket, e.g., right vs. left and maxillary vs. mandibular, to meet the various needs. The indicator could be a color (e.g. red vs. blue) or laser marked numbers of the specific teeth, for example.

It is also noted that while the prior art brackets are shown in an exterior application, the brackets 50, 150, 150′, 150″ and tubes 82, 182 may also be utilized in a lingual system and may be configured to be self-ligating. The brackets 50, 150, 150′, 150″ and tubes 82, 182 may be manufactured from metal, ceramic or plastic material, or any new material invented, either to improve esthetics and/or produce more resistant brackets and tubes, including 3-D printing of the brackets or tubes.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. An orthodontic device comprising:
a base having a central longitudinal plane; and
a plurality of posts extending relative to the base, each post extending from a connection portion to a free end and includes an internal surface which faces the central longitudinal plane, wherein each internal surface defines, starting at the connection portion, a first surface which is substantially parallel to the central longitudinal plane, an outwardly extending shoulder above the first surface and a second surface above the shoulder which is substantially parallel to the central longitudinal plane,
wherein the posts are positioned with a first subset of at least one post on one side of the central longitudinal plane and a second subset of at least one post positioned on the opposite side of the central longitudinal plane such that the facing first surfaces define a first slot with a first width and the facing second surfaces define a second slot above the first slot with a second width larger than the first width and wherein a space between the opposed shoulders defines a passage from the second slot to the first slot.

2. The orthodontic device according to claim 1, wherein the first width is about 0.018-inches and the second width is about 0.022-inches.

3. The orthodontic device according to claim 2, wherein the first slot has a height of between about 0.022-inches and about 0.025 inches.

4. The orthodontic device according to claim 3, wherein the second slot has a height of about 0.025 inches.

5. The orthodontic device according to claim 1, wherein a posterior surface of the base has a plurality of indentations thereon.

6. The orthodontic device according to claim 1, wherein the base has a curved configuration.

7. The orthodontic device according to claim 1, wherein at least one of the posts includes an indicator thereon configured to indicate the intended use position of the device.

8. The orthodontic device according to claim 1 including at least three posts, with the first and second subsets including at least two posts each.

9. The orthodontic device according to claim 8, wherein each of the posts is angled relative to the central longitudinal plane and a central transverse plane such that the posts converge toward the one another moving toward the base.

10. The orthodontic device according to claim 9, wherein the connection portion of each of the posts is connected to a pedestal which is connected to the base.

11. The orthodontic device according to claim 9 wherein a bridging portion extends between adjacent posts across the central transverse plane at least to the upper height of the second surfaces.

12. The orthodontic device according to claim 9, wherein the internal surface of each post defines a second outwardly extending shoulder above the second surface.

13. The orthodontic device according to claim 1, further comprising a covering portion extending across the second slot such that the first and second slots define an enclosed tubular passage.

14. An orthodontic device assembly comprising:
a plurality of devices according to claim 1; and
a double section archwire including a narrow portion configured to fit within the first slot and wide portion configured to fit within the second slot, the wide portion having a width larger than a width of the narrow portion.

15. An orthodontic device comprising:
a base defining a central longitudinal plane and a central transverse plane; and
at least four posts extending relative to the base with at least two posts on one side of the central longitudinal plane and at least two posts on the other side of the central longitudinal plane such that at least one slot is defined between the posts on opposite sides of the central longitudinal plane,
wherein each of the posts extends at a first angle of about 25 degrees or more relative to the central longitudinal plane and a second angle of about 25 degrees or more relative to the transverse longitudinal plane.

16. The orthodontic device according to claim 15 wherein the first angle is about 45 degrees or more and the second angle is about 45 degrees or more.

17. The orthodontic device according to claim 15 wherein a connection portion of each of the posts is connected to a pedestal which is connected to the base.

18. The orthodontic device according to claim 15 wherein each of the posts widens moving from a connection portion thereof to a free end thereof.

19. The orthodontic device according to claim 15 wherein a free end of each of the posts has rounded external corners.

20. The orthodontic device according to claim 15 wherein at least one of the posts is configured to receive and retain an interdental elastomeric band.

21. The orthodontic device according to claim 15 wherein the configuration between the posts and the base are configured to receive and retain ligature.

22. The orthodontic device according to claim 15 wherein an internal surface of each post is configured such that a second slot is defined between the posts on top of and in communication with the at least one slot.

23. The orthodontic device according to claim 15, further comprising a covering portion extending across the at least one slot such that the at least one slot defines an enclosed tubular passage.
